(19) United States
(12) Patent Application Publication
(10) Pub. No.: US 2024/0036727 A1
(43) Pub. Date: Feb. 1, 2024

(54) METHOD AND APPRATUS FOR BATCHING PAGES FOR A DATA MOVEMENT ACCELERATOR

(71) Applicants: Ren WANG, Portland, OR (US); Yifan YUAN, Sunnyvale, CA (US); Reese KUPER, Austin, TX (US)

(72) Inventors: Ren WANG, Portland, OR (US); Yifan YUAN, Sunnyvale, CA (US); Reese KUPER, Austin, TX (US)

(21) Appl. No.: 18/477,628

(22) Filed: Sep. 29, 2023

(51) Int. Cl. G06F 3/06

(52) U.S. Cl. CPC G06F 3/0608; G06F 3/0652; G06F 3/0665; G06F 3/067

(57) ABSTRACT

A method for batching pages for a data movement accelerator of a processor. The method includes determining a plurality of memory regions having a similar content according to a similarity criterion, wherein each memory region comprises a plurality of pages. The method further includes determining a plurality of page groups, wherein each page group comprises a plurality of counterpart pages between the plurality of memory regions. The method then includes providing the plurality of page groups to the data movement accelerator for parallel processing.

### BACKGROUND

In modern computing, multiple virtual memory regions may contain data equivalent to memory associated with other memory regions. In instances of cloud computing and large-scale data centers, the overall memory footprint resulting from identical data across all regions becomes significant and may result in less effective resource utilization. For instance, a cloud service provider may provide up to a certain number of virtual machines (VMs) to their clients as one of the main bottlenecks in offering more is the total memory available.

Different data deduplication techniques have been presented in the past, and the most commonly implemented in a Linux kernel is called Kernel Same-page Merging (KSM). However current KSM is performed via software in a synchronous programming model with no parallelism. It thus takes up a large part of central processing unit (CPU) resources and has always been a source of complaint. Therefore, an improved method and apparatus for implementing KSM is desired.

### BRIEF DESCRIPTION OF THE FIGURES

Some examples of apparatuses and/or methods will be described in the following by way of example only, and with reference to the accompanying figures, in which

FIG. 1 shows a flowchart of a method for batching pages for a data movement accelerator of a processor;

FIG. 2 shows a KSM process flow;

FIG. 3 shows a system architecture for KSM with and without a data movement accelerator;

FIG. 4 shows relative page grouping for KSM preprocessing;

FIG. 5 shows async-based software-accelerator interaction for page comparison in KSM;

FIG. 6 shows a flowchart of a method for using a data movement accelerator of a processor in page merging;

FIGS. 7A and 7B show an analysis of a performance impact of offloading relevant KSM operations to a data movement accelerator; and

FIG. 8 shows a schematic diagram of an example of an apparatus or device for performing at least one method.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

When two elements A and B are combined using an “or,” this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an,” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise,” and/or “comprising,” when used, describe the presence of the specified features, integers, steps, operations, processes, elements, components, and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating,” “executing,” or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

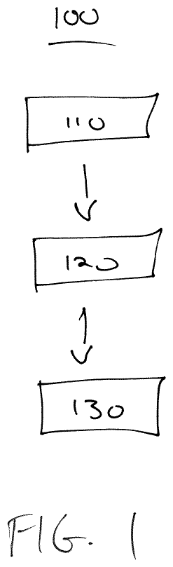

FIG. 1 shows a method 100 of batching pages for a data movement accelerator of a processor. The method includes determining 110 a plurality of memory regions having a similar content according to a similarity criterion, wherein each memory region comprises a plurality of pages. The method also includes determining 120 a plurality of page groups, wherein each page group comprises a plurality of counterpart pages between the plurality of memory region. The method additionally includes providing 130 the plurality of page groups to the data movement accelerator for parallel processing.

In modern computing, multiple virtual memory regions may contain data equivalent to memory associated with other memory regions. In instances of cloud computing and large-scale data centers, the overall memory footprint resulting from identical data across all regions becomes significant and may result in less effective resource utilization. For instance, a cloud service provider may provide up to a certain number of virtual machines (VMs) to their clients as one of the main bottlenecks in offering more is the total memory available.

Various data deduplication techniques exist with the most commonly implemented in the Linux kernel called kernel same-page merging (KSM). However, one large factor limiting KSMs' use in large-scale settings is the computationally expensive nature of the feature. KSM occupies significant processing time and pollutes cache since memory comparisons and checksums are computed on the central processing unit (CPU) cores. Additionally, these computations bring a large amount of data (e.g. pages) into the cache and act antagonistically to other co-running applications. Because KSM is often performed via software in a synchronous programming model with no parallelism, it may take up a large part of CPU resources and become a source of complaint.

An on-chip data movement (e.g. data-streaming) accelerator for handling the memory page merging issues may be used to perform these computations. Through using accelerators to efficiently offload the menial but time-intensive sub-tasks, KSM can be greatly improved in performance. For example, software programming models may efficiently utilize the on-chip accelerator in beneficial ways compared to software-only solutions. To effectively use the on-chip accelerator, a method may include batching memory-intensive sub-processes through relative page inter-group batching. Further, the method may include an asynchronous programming model to further assist the new batch processing model. Both may alleviate the computational caching overhead by moving the main processing off the main CPU core to overcome the issue in performance and by mitigating cache pollution in the process. This may provide significant performance improvement and prevent the CPU cache from being polluted.

A data movement accelerator may be a specialized, energy-efficient hardware component or subsystem designed to improve the efficiency and speed of data transfer and manipulation within a computer system—particularly, when compared to general CPUs. They are often used to accelerate data-intensive tasks that involve moving, transforming, or processing large volumes of data between different memory hierarchies or components of a computer system. This may be accomplished by offloading these tasks from the CPU. Data movement accelerators are particularly valuable in scenarios where traditional processor cores may not be efficient or fast enough to handle the data movement requirements. They may support the processor by using dedicated busses or data paths to active higher data transfer speeds between various memory types such as main system memory (RAM), cache memory, storage devices. They may include hardware support for data transformation tasks, such as compression, decompression, encryption, decryption, data formatting, and data encoding or decoding. Some accelerators are designed to predictively fetch data from memory or storage before it is needed by the processor, reducing data access latency, and improving overall system performance. And data movement accelerators may leverage parallel processing to handle multiple data streams simultaneously, further enhancing their data processing capabilities.

An on-chip accelerator may be included on a CPU to enable fast memory movement and operational features through an on-chip hardware accelerator. This accelerator may speed up operations for memory comparisons, calculating cyclic redundancy check (CRC) checksums, copying data from one location to another, and more. These operations may be suitable for improving KSM by reducing high CPU utilization and cache pollution. Accelerator memory comparisons may be used when comparing memory pages with one another and accelerator memory copying may be done when the page is merged to obfuscate the merged page's location.

CRC checksums are a type of error-checking code used in computing to detect errors in data transmission or storage. They are commonly used in network communication protocols, file storage systems, and data transmission over unreliable channels. CRC checksums work by generating a fixed-size checksum value from the data being transmitted or stored and appending it to the data. When the data is received or read, the CRC checksum is recalculated, and if it doesn't match the originally transmitted checksum, it indicates that an error has occurred.

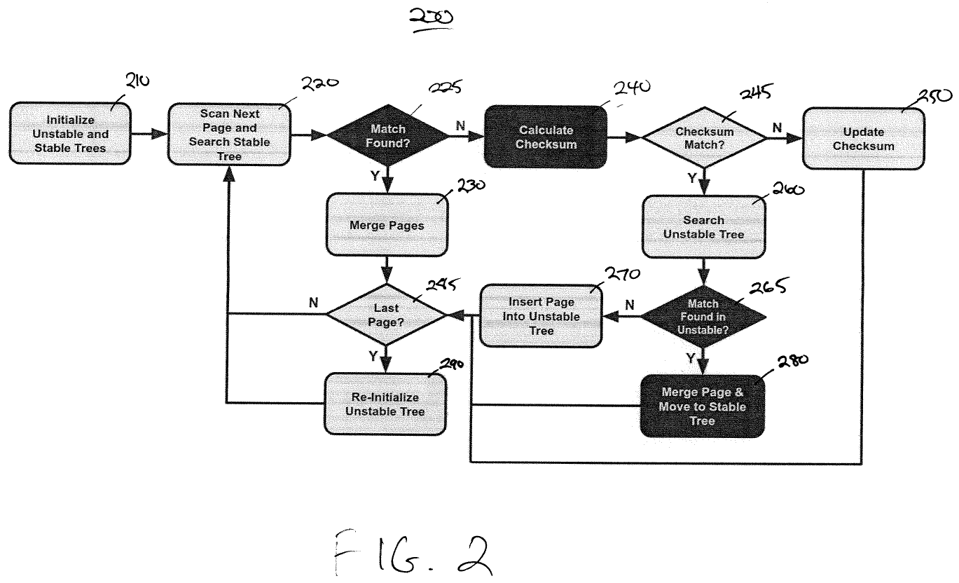

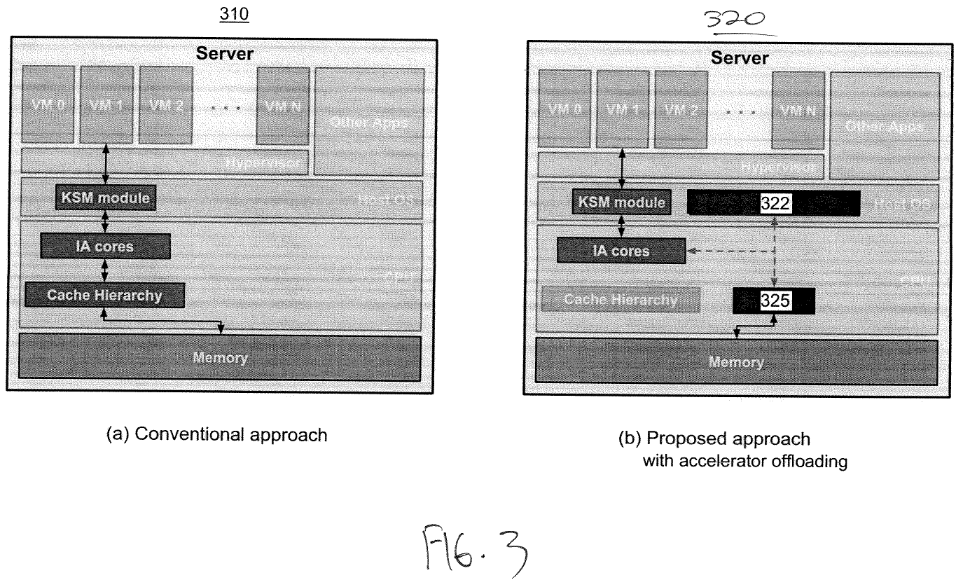

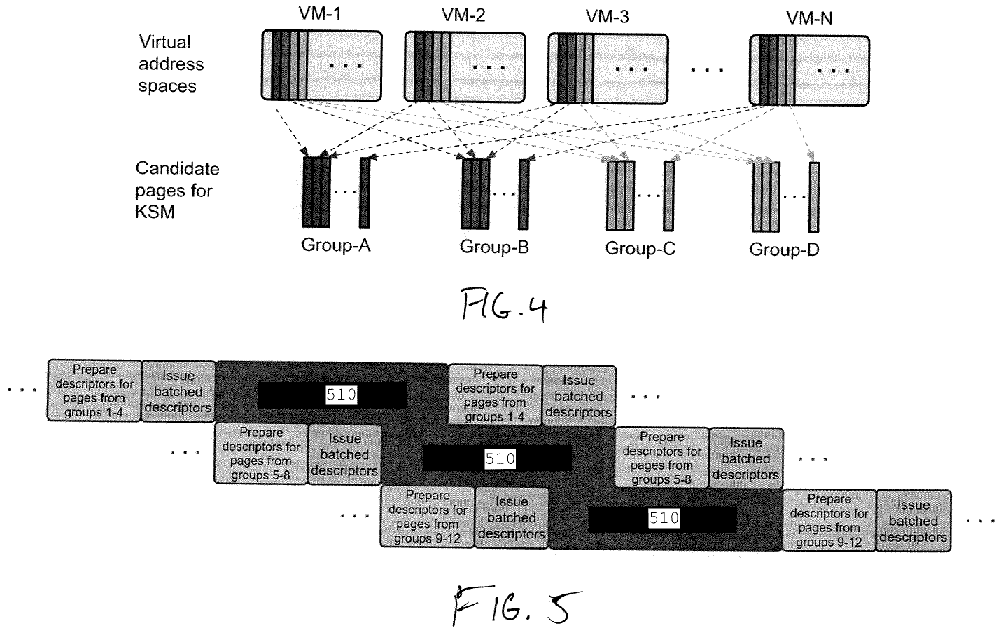

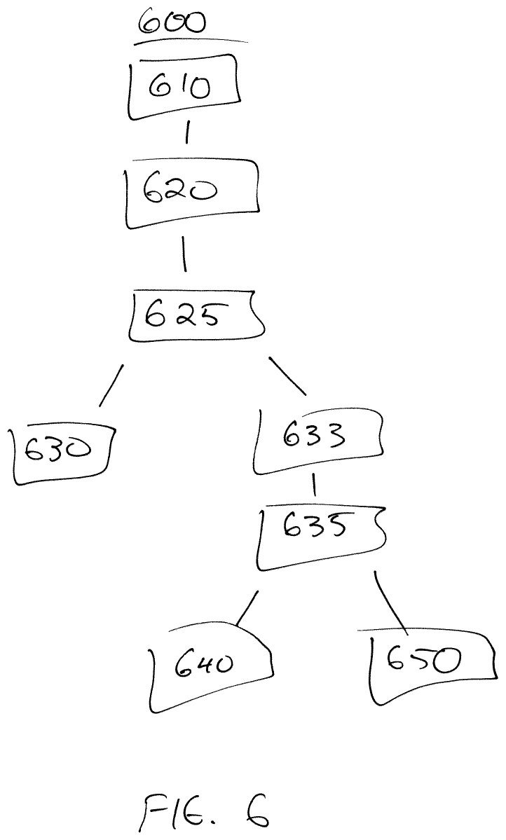

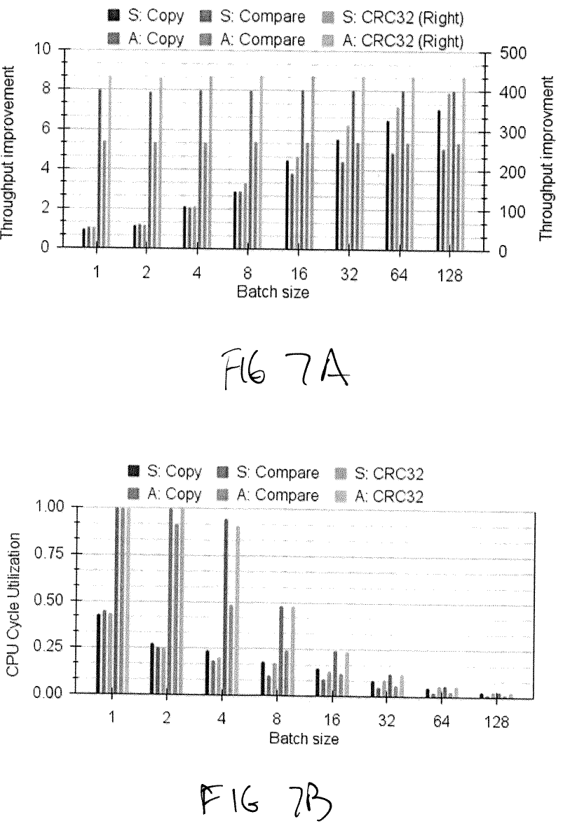

FIG. 2 shows a KSM process flow 200. Memory is a critical resource in data centers and is one of the limiting factors in the number of VM services offered by cloud providers. Due to the importance of reducing memory usage in these platforms, memory deduplication techniques are vital. KSM serves to combine duplicated pages found in memory regions, reducing the overall space these regions consume. In virtualized environments, this process of scanning, combining, and checksum calculating pages falls on the host machine to manage. Since numerous critical processes must be run on the host, the goal is to mitigate the time spent on KSM-related tasks.

The process 200 starts by creating two tree data structures 210, often called a stable and unstable tree. The unstable tree is rebuilt after every scan and only contains pages that are not frequently changed (e.g. good candidates for merging). The stable tree holds pages that have already been merged and is persistent across scans. Next, the process loads the next page within the memory region and checks the current page with pages within the stable tree 220 for a match 225. If a match is found, the current page and memory and the stable page are merged and the process has finished the page compare (FPC). If a match to the stable tree isn't found, the process calculates 240 the checksum hash of the current page to find a match 245. The KSM algorithm considers infrequently modified pages to be the best candidates for merging. Checksums are used in these cases to quickly compare if a page has changed since the last time that page has been scanned and can be offloaded to the on-chip accelerator as well. This reduces the number of false negatives from the unstable tree lookups, and a checksum is used to insert into the unstable tree only pages whose checksum didn't recently change. If the checksum does not match the page's stored value, the value of the checksum is updated 250 and the process 200 has finished its page compare (FPC). If there is a checksum match, the process 200 then checks the current page with pages with the unstable tree 260 for a match 265. If the match is found, the process 200 combines both pages, places the merged page in the stable tree 280, and conducts the FPC. If no match is found, the page is inserted 270 into the unstable tree.

When the process 200 has finished the page compare (FPC), it then checks to see if the current page was the last page in memory 285. If it is, the unstable tree is reinitialized 290, otherwise, the process 200 begins again with the scan and search of the stable tree 220 for the next memory page.

KSM is a popular memory deduplication technique used within the Linux kernel but suffers from high CPU utilization and may contribute to significant amounts of cache pollution. Through using accelerators to efficiently offload the menial but time-intensive sub-tasks, KSM can be greatly improved in performance. An on-chip data accelerator may provide a rich set of data manipulation for certain operations. For instance, memory comparisons, CRC checksum calculations, memory dual-casting, and additional operations may all be enabled through this accelerator. FIG. 3 shows a system architecture for KSM with an on-chip or data streaming accelerator 330 and a conventional architecture without one 310. The accelerator 325 has a software interface 322 within the host OS.

Some on-chip data accelerator operations include: A memory move, to transfer data from a source address to a destination address. CRC generation, to generate a checksum on the transferred data. A data integrity field check. Dual-casting, to copy data simultaneously to two destination locations. Memory fill, to fill a memory range with a fixed pattern. Memory compare, to compare two source buffers and return whether the buffers are identical. Creating a delta record containing the differences between the original and modified buffers. Merging a delta record with the original source buffer to produce a copy of the modified buffer at the destination location. Pattern or zero detection to compare a buffer with an 8-byte pattern, which may include zeros. And a cache flush, to evict all lines in a given address range from all levels of CPU caches.

Performant and feature-rich on-chip or data movement accelerators (e.g., with the ability for asynchronous and batched offloading) can be utilized to enhance the performance of the KSM algorithm. Some on-chip accelerator operations line up very well with the work done by the KSM process. For example, the finding matches 225, 265, calculating checksums 240, and merging and moving pages to the stable tree 280 can be offloaded from a CPU to an on-chip accelerator. For instance, memory compare enables the use of the on-chip accelerator to compare memory of any specified size, like performing page comparisons for the current page and the stable or unstable tree. Page checksums are also able to be calculated by an on-chip accelerator through the CRC generation operation.

By (partially) offloading KSM to an on-chip-accelerator, a more efficient and performant solution with less performance interference and security concerns may be achieved. Based on the current software KSM flow, a naïve way offloading of KSM to an on-chip accelerator may be performed.

As shown in FIG. 2, two operations may be directly offloaded to an on-chip accelerator using a naïve implementation. First, comparing a page in the stable and unstable trees. This operation may simply compare whether the target page fully matches with a page in the tree. This can be done with an on-chip accelerator's memory compare operation. Second, calculating a checksum of a page to see whether it has been recently updated. This can be done with an accelerator's CRC generation operation. Since these two operations require touching the entire 4 KB content of a page, they are the most expensive operations in KSM, consuming 34% and 25% of total CPU cycles for KSM, respectively.

With the current linear and sync execution, one can directly replace the corresponding software code of these two operations by issuing accelerator descriptors and waiting (UMWAIT) for the completion record and proceeding to the next stage. However, the benefits are not fully realized due to the offloading nature of synchronously using an accelerator with no descriptor batching. By tailoring the algorithm to the benefits and unique features of the on-chip accelerator a more efficient version of KSM may be implemented. KSM may be parallelized and may exploit the async programming models of on-chip accelerators (e.g. hardware-software co-design), using software-level hints and optimized execution flow.

FIG. 1 shows this adaptive batching method where asynchronous CPU and accelerator processing may be used to overcome KSM overhead and ensure optimal performance. Using and coordinating (e.g. pipelining) multiple operations (CRC, compare, move) of an on-chip accelerator may enable more complicated use cases to leverage the accelerators that are more complicated than a straightforward memory move. Specifically, adaptive batching and an async programming model are described to make better use of the on-chip accelerator and its unique attributes.

Each of the plurality of memory regions being referenced in the method 100 may be spawned by booting from an identical file. This may make it easier to determine which memory regions have similar content. Partially offloading KSM to a data accelerator may provide a more efficient and performant solution with less performance interference and security concerns. Adaptively batching more relevant pages together, such as those booted from an identical file, along with the carefully designed asynchronous model may allow for a more efficient pipelining for usages like KSM.

The plurality of memory regions may be memory regions of virtual machines. KSM is most useful in scenarios where multiple VM instances with the same VM image are running on the same host platform. This is because, in such situations, pages in different VM instances are more likely to be the same, creating good conditions for the potential page merge.

FIG. 4 shows relative page grouping for KSM preprocessing 400. An on-chip accelerator can manage batched operations and hold many operations in-flight, both leading to either reduced offloading overhead or significantly higher observable throughput. This may be accomplished by using “relative page inter-group batching” to group candidate pages by the same relative page address across VMs while batching between these groups and asynchronously conducting comparisons via the on-chip accelerator. This effectively amortizes the access latency to the accelerator, allows CPU cores to perform other tasks in parallel, and fully utilizes the accelerator processing capability. The design is derived from two observations:

The plurality of counterpart pages may include equivalent data. The same virtual address (page) in different VM instances may refer to the same context (but the actual content can be different). For example, suppose there are VM instances 1 and 2, which are booted from the same image. If a page starting with virtual address X in VM-1 contains the code “glibc” denoting the GNU C Library (GLIBC), then the page starting with virtual address X in VM-2 also contains the code “glibc”. Such pages may be called “same-position pages” across VM instances. GLIBC is a core component of the GNU operating system and many Unix-like systems. It is a C library that provides essential system calls and libraries for programming in the C and C++ languages. Thus it may be a good candidate for KSM. Furthermore, the same-page merge will be most likely to happen inside the “same-position pages” across VM instances, as many of such pages are common, and the actual data is unlikely to change after initialization. Since common libraries may be found in common positions, particularly if they are booted from the same image, candidates from page merging can be found quickly and efficiently simply by looking at common locations.

The plurality of counterpart pages may include identical checksums. Some operations line up very well with the work done by the KSM process and can be seen in FIG. 3 by the operations in the dark blue background. For instance, memory compare enables the use of the accelerator to compare memory of any specified size, like performing page comparisons for the current page and the stable or unstable tree. Page checksums are also able to be calculated by the accelerator through the CRC generation operation.

The plurality of counterpart pages may be located at equivalent addresses relative to the respective memory region. The method may include grouping “same-position pages” as a pre-processing operation of KSM (demonstrated in FIG. 3). That is, when invoking the KSM functionality, the host hypervisor/OS first groups each “same-position page” from all candidate memory regions VMs together. For each “same-position page” group, the corresponding stable tree and unstable tree are initialized. Then, during KSM, pages in each group will still be scanned and compared sequentially; however, pages from different groups can be operated in parallel. Note that page grouping requires exposing virtual address hints to the host OS/hypervisor, so that same position pages can be identified and classified.

Exposing an address may be performed to enable determining that pages are in the same relative position. This allows the translation of virtual addresses to physical addresses so that the same pages can be batched together more easily. Each memory region or VM may need an address translation so that the same page batching can occur across memory regions.

The novelty of this approach is to go beyond the general use of an on-chip data movement accelerator (as seen through the CRC and comparison operations) and simple batching. It proposes novel, adaptive batching and more importantly, restructuring the way the algorithm use case (KSM) flows by exposing better batching opportunities and asynchronous operation of these key memory tasks. For instance, batching in accordance with relative memory space address builds upon and improves the current design of KSM that allows better coordination with the accelerator, which is uniquely well-suited for this usage.

FIG. 5 shows async-based software-accelerator interaction for page comparison in KSM. “Relative page inter-group batching” is introduced for higher efficiency. The counterpart pages in each page group may be compared by the data movement accelerator 510 for merging. As demonstrated in FIG. 5, take the “search stable tree” operation as an example, suppose there are 12 “same-position page” groups. Instead of completing each page scan and moving to the next candidate page, the batching method first selects one candidate page in each of the first 4 “same-position page” groups and prepares them for the first iteration of searching the corresponding unstable trees. Also, an accelerator descriptor is prepared for each page comparison operation. Then, the four compare descriptors are issued in a batch to the accelerator engine and moved to the next batch, where the four pages from group 5-8 will be prepared and compared. The same thing happens with the last batch (group 9-12). Once the accelerator descriptors of the first batch are completed, according to the comparison result, the search is iterated to the next node in the corresponding unstable trees, or, upon a match, excludes a page from the next-iteration tree search. Similarly, the actual page comparison operations are done by accelerator 510 in an async manner.

FIG. 6 shows a method 600 for using a data movement accelerator of a processor in page merging, wherein the processor is associated with a memory. The method 600 includes loading 620 a candidate page and stored checksum from memory and merging 630 the candidate page into with a page of a first data structure when the candidate page matches or is determined 625 to be a page of the first data structure. The first data structure includes a plurality of pages. If no match is found among the pages of the first data structure, a current checksum of the candidate page is calculated 633. If the checksum matches the stored checksum of the candidate page, then the method 600 further includes inserting 640 the candidate page into a second data structure if no match between the candidate page and second data structure is found or is determined 635. The second data structure includes a plurality of pages. Otherwise, the method 600 includes merging 650 the candidate page with a page of the second data structure and moving the merged page to the first data structure. The data movement accelerator may perform the determining 625 a match between the candidate page and the pages of the first data structure, determining 635 a match between the candidate page and the pages of the second data structure, and calculating the current checksum 633.

The method 600 may further include batching 610 pages for the data movement accelerator from a plurality of memory regions, wherein each memory region comprises a plurality of candidate pages, where a plurality of page groups are determined, and where each page group comprises a plurality of counterpart pages between the plurality of memory regions. A separate first and second data structure may be used for each page group and the plurality of page groups are provided to the data movement accelerator for parallel processing.

Grouping “same-position pages” may be done as a pre-processing operation of KSM as shown in FIG. 5. That is, when invoking the KSM functionality, the host hypervisor/OS first groups each “same-position page” from all candidate memory regions or VMs together. For each “same-position page” group, the corresponding stable tree and unstable tree are initialized. Then, during KSM, pages in each group will still be scanned and compared sequentially; however, pages from different groups can be operated in parallel. Page grouping may require exposing virtual address hints to the host OS/hypervisor, so that same position pages can be identified and classified.

For software-accelerator interaction, an async programming model may further improve the KSM efficiency and unleash the accelerator's capability, as shown in FIG. 5. For illustration purposes, only 3 batches (each with 4 pages) in the pipeline are shown. However, accelerator computing operations may take much longer than the software parts in real usage. Hence, larger batch sizes and more outstanding batches may be required. Also note that other parts of KSM for different pages, which are not offloaded to the accelerator, may still be executed sequentially and synchronously in software.

The plurality of memory regions in method 600 may be spawned by booting from an identical file. And the plurality of memory regions are memory regions of virtual machines. This may increase the likelihood that the memory regions contain more candidate data for merging. The plurality of counterpart pages may include equivalent data or may include identical checksums. This may further increase the likelihood that counterpart pages are good candidates for merging. The plurality of counterpart pages may be located at equivalent addresses relative to the respective memory region. The first data structure in method 600 may be a stable tree and the second data structure may be an unstable tree.

FIGS. 7A and 7B show analysis for offloading relevant KSM operations to a data movement accelerator. FIG. 7A shows operation throughput improvements using a data movement accelerator for relevant KSM operations. CRC32 is displayed on the right axes due to high speedup. For all relevant operations, throughput improvements are seen right away for all operations with only a synchronous 4 KB memory copy through the accelerator being nearly equivalent to its CPU software counterpart in FIG. 7A. The greater the operation can be batched, the offload latency of the operations is significantly reduced, resulting in increased benefits. Due to CRC32 being a more computational operation, hardware acceleration brings high speedups between 50-440× depending on the level of synchronicity.

FIG. 7B shows CPU cycle utilization using an on-chip data movement accelerator for relevant KSM operations. The figure shows the CPU cycles spent running the relevant operations on the accelerator. When the operations are serviced on the accelerator, the offloading core is free to run other processes while waiting for the completion of the offloaded work. Complete asynchronous usage of the accelerator uses more cycles for offloading more descriptors but still opens CPU time once descriptors are batched. Realistic use cases of the accelerator can see moderate asynchronicity and batching to exhibit both high throughput and low CPU cycle utilization. Moreover, as we explained before, since the accelerator can perform the memory comparison in the DRAM, there is no need to bring those pages into the CPU cache, this would avoid polluting the precious cache resources, and help applications running on the cores.

An apparatus for a processor or data movement accelerator may also perform the methods outlined above. The apparatus may be a processor or data movement accelerator as described above. The hardware-software co-design approach to optimize the important KSM service by leveraging an on-chip accelerator may allow for batching candidate pages by the same relative page address across memory regions or VMs (“relative page inter-group batching”) and asynchronously conducting comparisons and CRC via the accelerator. This approach may free the CPU from those heavy-duty operations and also may effectively amortize the access latency to the accelerator. It may also allow CPU cores to perform other tasks in parallel and fully utilize the accelerator processing capability. On top of the performance benefit, this approach may greatly reduce CPU cache pollution due to KSM's heavy memory operations.

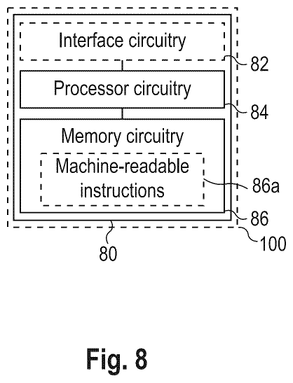

FIG. 8 shows a schematic diagram of an example of an apparatus 80 or device 80 for performing at least one method shown in the present disclosure, such as the method of FIG. 1, the method of FIG. 2, and/or the method of FIG. 6. FIG. 8 further shows a computer system 800 comprising such an apparatus 80 or device 80. The apparatus 80 comprises circuitry to provide the functionality of the apparatus 80. For example, the circuitry of the apparatus 80 may be configured to provide the functionality of the apparatus 80. For example, the apparatus 80 of FIG. 8 comprises optional interface circuitry 82, processor circuitry 84, and memory circuitry 86. For example, the processor circuitry 84 may be coupled with the interface circuitry 82, and with the memory circuitry 86. For example, the processor circuitry 84 may provide the functionality of the apparatus, in conjunction with the interface circuitry 82 (for exchanging information, e.g., with other components inside or outside the computer system 800 comprising the apparatus 80 or device 80), the memory circuitry 86 (for storing information, such as machine-readable instructions). Likewise, the device 80 may comprise means for providing the functionality of the device 80. For example, the means may be configured to provide the functionality of the device 80. The components of the device 80 are defined as component means, which may correspond to, or be implemented by, the respective structural components of the apparatus 80. For example, the device 80 of FIG. 8 comprises means for processing 84, which may correspond to or be implemented by the processor circuitry 84, means for communicating 82, which may correspond to or be implemented by the interface circuitry 82, (optional) means for storing information 86, which may correspond to or be implemented by the memory circuitry 86. In general, the functionality of the processor circuitry 84 or means for processing 84 may be implemented by the processor circuitry 84 or means for processing 84 executing machine-readable instructions. Accordingly, any feature ascribed to the processor circuitry 84 or means for processing 84 may be defined by one or more instructions of a plurality of machine-readable instructions. The apparatus 80 or device 80 may comprise the machine-readable instructions, e.g., within the memory circuitry 86, a storage circuitry (not shown), or means for storing information 86. For example, the processor circuitry 84 or means for processing 84 may perform a method shown in the present disclosure, such as the method discussed in connection with FIG. 1, the method discussed in connection with FIG. 2, or the method discussed in connection with FIG. 6.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, or any means for processing, such as a processor, a computer, or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a microcontroller, etc.

For example, the memory circuitry 16 or means for storing information 16 may be a volatile memory, e.g., random access memory, such as dynamic random-access memory (DRAM) or static random-access memory (SRAM).

For example, the computer system 100 may be at least one of a client computer system, a server computer system, a rack server, a desktop computer system, a mobile computer system, a security gateway, and a router. The mobile device 100 may be one of a smartphone, tablet computer, wearable device, or mobile computer.

An example (e.g. example 1) relates to a method of batching pages for a data movement accelerator of a processor, the method comprising determining a plurality of memory regions having a similar content according to a similarity criterion, wherein each memory region comprises a plurality of pages; determining a plurality of page groups, wherein each page group comprises a plurality of counterpart pages between the plurality of memory regions; and providing the plurality of page groups to the data movement accelerator for parallel processing.

Another example (e.g. example 2) relates to a previously described example (e.g. example 1), wherein each of the plurality of memory regions are spawned by booting from an identical file.

Another example (e.g. example 3) relates to a previously described example (e.g. example 2), wherein the plurality of memory regions are memory regions of virtual machines.

Another example (e.g. example 4) relates to a previously described example (e.g. one of the examples 1-3), wherein the plurality of counterpart pages comprise equivalent data.

Another example (e.g. example 5) relates to a previously described example (e.g. one of the examples 1-4), wherein the plurality of counterpart pages comprise identical checksums.

Another example (e.g. example 6) relates to a previously described example (e.g. one of the examples 1-5), wherein the plurality of counterpart pages are located at equivalent addresses relative to the respective memory region.

Another example (e.g. example 7) relates to a previously described example (e.g. one of the examples 1-6), wherein the counterpart pages in each page group are compared by the data movement accelerator for merging.

An example (e.g. example 8) relates to an apparatus for batching pages for a data movement accelerator of a processor, the apparatus comprising memory circuitry, machine-readable instructions, and processor circuitry to execute the machine-readable instructions to perform the method of a previously described example (e.g. one of the examples 1-7).

An example (e.g. example 9) relates to an apparatus for batching pages for a data movement accelerator of a processor, the apparatus comprising processor circuitry configured to the method of a previously described example (e.g. one of the examples 1-7).

An example (e.g. example 10) relates to a device for batching pages for a data movement accelerator of a processor, the device comprising means for performing the method of a previously described example (e.g. one of the examples 1-7).

An example (e.g. example 11) relates to a non-transitory, computer-readable medium comprising a program code that, when the program code is executed on a processor, a computer, or a programmable hardware component, causes the processor, computer, or programmable hardware component to the method of a previously described example (e.g. one of the examples 1-7).

An example (e.g. example 12) relates to a computer program having a program code for performing the method of a previously described example (e.g. one of the examples 1-7) when the computer program is executed on a computer, a processor, or a programmable hardware component.

An example (e.g. example 13) relates to a method for using a data movement accelerator of a processor in page merging, wherein the processor is associated with a memory, the method comprising loading a candidate page and stored checksum from memory; merging the candidate page into with a page of a first data structure if the candidate page matches a page of the first data structure, the first data structure comprising a plurality of pages; and if no match is found in among the pages of the first data structure and a current checksum of the candidate page matches the stored checksum of the candidate page, inserting the candidate page into a second data structure if no match is found between the candidate page and a plurality of pages of the second data structure, or merging the candidate page with a page of the second data structure and moving the merged page to the first data structure, wherein at least one of determining a match between the candidate page and the pages of the first data structure, determining a match between the candidate page and the pages of the second data structure and calculating the current checksum is performed using the data movement accelerator.

Another example (e.g. example 14) relates to a previously described example (e.g. example 13), further comprising batching pages for the data movement accelerator from a plurality of memory regions, wherein each memory region comprises a plurality of candidate pages, wherein a plurality of page groups are determined, wherein each page group comprises a plurality of counterpart pages between the plurality of memory regions; and a separate first and second data structure are used for each page group, and the plurality of page groups are provided to the data movement accelerator for parallel processing.

Another example (e.g. example 15) relates to a previously described example (e.g. example 14), wherein each of the plurality of memory regions are spawned by booting from an identical file.

Another example (e.g. example 16) relates to a previously described example (e.g. examples 14-15), wherein the plurality of memory regions are memory regions of virtual machines.

Another example (e.g. example 17) relates to a previously described example (e.g. one of the examples 14-16), wherein the plurality of counterpart pages comprise equivalent data.

Another example (e.g. example 18) relates to a previously described example (e.g. one of the examples 14-17), wherein the plurality of counterpart pages comprise identical checksums.

Another example (e.g. example 19) relates to a previously described example (e.g. one of the examples 14-18), wherein the plurality of counterpart pages are located at equivalent addresses relative to the respective memory region.

Another example (e.g. example 20) relates to a previously described example (e.g. one of the examples 13-19), wherein the first data structure is a stable tree and the second data structure is an unstable tree.

An example (e.g. example 21) relates to an apparatus for using a data movement accelerator of a processor in page merging, the apparatus comprising memory circuitry, machine-readable instructions, and processor circuitry to execute the machine-readable instructions to perform the method of a previously described example (e.g. one of the examples 13-20).

An example (e.g. example 22) relates to an apparatus for using a data movement accelerator of a processor in page merging, the apparatus comprising processor circuitry configured to perform the method of a previously described example (e.g. one of the examples 13-20).

An example (e.g. example 23) relates to a device for using a data movement accelerator of a processor in page merging, the device comprising means for performing the method of a previously described example (e.g. one of the examples 13-20).

An example (e.g. example 24) relates to a non-transitory, computer-readable medium comprising a program code that, when the program code is executed on a processor, a computer, or a programmable hardware component, causes the processor, computer, or programmable hardware component to perform the method of a previously described example (e.g. one of the examples 1-7).

An example (e.g. example 25) relates to a non-transitory machine-readable storage medium including program code, when executed, to cause a machine to perform the method of a previously described example (e.g. one of the examples 13-20).

An example (e.g. example 26) relates to a computer program having a program code for performing the method of a previously described example (e.g. one of the examples 13-20).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes, or -operations.

If some aspects have been described in relation to a device or system, these aspects should also be understood as a description of the corresponding method. For example, a block, device, or functional aspect of the device or system may correspond to a feature, such as a method step, of the corresponding method. Accordingly, aspects described in relation to a method shall also be understood as a description of a corresponding block, a corresponding element, a property, or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect, feature, or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation. The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed unless it is stated in the individual case that a particular combination is not intended. Furthermore, features of a claim should also be included for any other independent claim, even if that claim is not directly defined as dependent on that other independent claim.

What is claimed is:

1. A method of batching pages for a data movement accelerator of a processor, the method comprising:
determining a plurality of memory regions having a similar content according to a similarity criterion, wherein each memory region comprises a plurality of pages;
determining a plurality of page groups, wherein each page group comprises a plurality of counterpart pages between the plurality of memory regions; and
providing the plurality of page groups to the data movement accelerator for parallel processing.

2. The method of claim 1, wherein each of the plurality of memory regions are spawned by booting from an identical file.

3. The method of claim 2, wherein the plurality of memory regions are memory regions of virtual machines.

4. The method of claim 1, wherein the plurality of counterpart pages comprise equivalent data.

5. The method of claim 1, wherein the plurality of counterpart pages comprise identical checksums.

6. The method of claim 1, wherein the plurality of counterpart pages are located at equivalent addresses relative to the respective memory region.

7. The method of claim 1, wherein the counterpart pages in each page group are compared by the data movement accelerator for merging.

8. An apparatus for batching pages for a data movement accelerator of a processor, the apparatus comprising memory circuitry, machine-readable instructions, and processor circuitry to execute the machine-readable instructions to perform the method of claim 1.

9. A non-transitory, computer-readable medium comprising a program code that, when the program code is executed on a processor, a computer, or a programmable hardware component, causes the processor, computer, or programmable hardware component to perform the method of claim 1.

10. A method for using a data movement accelerator of a processor in page merging, wherein the processor is associated with a memory, the method comprising:
loading a candidate page and a stored checksum from memory;
merging the candidate page with a page of a first data structure if the candidate page matches a page of the first data structure, the first data structure comprising a plurality of pages; and
if no match is found among the pages of the first data structure and a current checksum of the candidate page matches the stored checksum of the candidate page,
inserting the candidate page into a second data structure if no match is found between the candidate page and a plurality of pages of the second data structure,
or merging the candidate page with a page of the second data structure and moving the merged page to the first data structure,
wherein at least one of determining a match between the candidate page and the pages of the first data structure, determining a match between the candidate page and the pages of the second data structure, and calculating the current checksum is performed using the data movement accelerator.

11. The method of claim 10, further comprising batching pages for the data movement accelerator from a plurality of memory regions, wherein each memory region comprises a plurality of candidate pages, wherein
a plurality of page groups are determined, wherein each page group comprises a plurality of counterpart pages between the plurality of memory regions; and
a separate first and second data structure are used for each page group, and
the plurality of page groups are provided to the data movement accelerator for parallel processing.

12. The method of claim 11, wherein each of the plurality of memory regions are spawned by booting from an identical file.

13. The method of claim 11, wherein the plurality of memory regions are memory regions of virtual machines.

14. The method of claim 11, wherein the plurality of counterpart pages comprise equivalent data.

15. The method of claim 11, wherein the plurality of counterpart pages comprise identical checksums.

16. The method of claim 11, wherein the plurality of counterpart pages are located at equivalent addresses relative to the respective memory region.

17. The method of claim 11, wherein the first data structure is a stable tree and the second data structure is an unstable tree.

18. An apparatus for using a data movement accelerator of a processor in page merging, the apparatus comprising memory circuitry, machine-readable instructions, and processor circuitry to execute the machine-readable instructions to perform the method of claim 10.

19. A non-transitory, computer-readable medium comprising a program code that, when the program code is executed on a processor, a computer, or a programmable hardware component, causes the processor, computer, or programmable hardware component to perform the method of claim 10.
